(19) United States
(12) Patent Application Publication
(10) Pub. No.: US 2020/0024986 A1
(43) Pub. Date: Jan. 23, 2020

(54) GAS TURBINE ENGINE COMPONENT

(71) Applicant: ROLLS-ROYCE plc, London (GB)

(72) Inventors: Luca DI MARE, London (GB); Max E. RIFE, London (GB); Fernando BARBAROSSA, London (GB)

(73) Assignee: ROLLS-ROYCE plc, London (GB)

(21) Appl. No.: 16/273,345

(22) Filed: Feb. 12, 2019

(30) Foreign Application Priority Data
Mar. 6, 2018 (GB) 1803571.7

(51) Int. Cl. F01D 9/02

(52) U.S. Cl. CPC F01D 9/02; F05D 2240/12

(57) ABSTRACT

There is disclosed a component arranged to extend across a bypass duct (22) of a gas turbine engine (10), comprising: an outlet guide vane (24); and a structural support (26) arranged to structurally support a radially inner component of the gas turbine engine (10). The outlet guide vane (24) and the structural support (26) are contiguous at a merged portion (32) which is at a radially outer region of the component.

### CROSS-REFERENCE TO RELATED APPLICATIONS

This specification is based upon and claims the benefit of priority from UK Patent Application Number 1803571.7 filed on 8 Mar. 2018, the entire contents of which are incorporated herein by reference.

### BACKGROUND

### Technical Field

The disclosure relates to a component for a gas turbine engine comprising an outlet guide vane and a structural support such as a pylon.

### Description of the Related Art

A typical gas turbine for aircraft propulsion comprises an axial fan driven by an engine core. The engine core is generally made up of one or more turbines which drive respective compressors via coaxial shafts. The fan is usually driven by an additional lower pressure turbine in the engine core. The flow handled by the fan provides a major contribution to the thrust of the engine and is discharged through of outlet guide vanes (OGV) and through a bypass duct, which surrounds the rear part of the engine.

The bypass duct is split into crescent shaped portions downstream of the OGV by one or more pylons (which may also be referred to as bifurcations). The pylons are needed to host structures connecting the engine to the airframe as well as connecting lines for electrical power, fuel, oil and service air, or mechanical elements driving auxiliary machinery located on the fan case and driven by a core-mounted gear box.

The presence of the pylons means that downstream of the OGVs the bypass duct is asymmetric. The fan rotates past a non-uniform flow field as a result of the asymmetry of the bypass duct and as a result of the asymmetry of the intake duct. Under certain conditions the magnitude and pattern of the flow non-uniformity in proximity of the fan may be sufficient to reduce the fan operating range and to give rise to high levels of forcing on the fan blades. This phenomenon is undesirable and provisions are needed to reduce flow non-uniformity experienced by the fan.

It may therefore be desirable to provide an improved arrangement.

### SUMMARY

According to an aspect there is provided a component arranged to extend across a bypass duct of a gas turbine engine, comprising: an outlet guide vane; and a structural support, or pylon, arranged to structurally support a radially inner component of the gas turbine engine; wherein the outlet guide vane and the structural support are contiguous at a merged portion which is at a radially outer region of the component, and the merged portion has a radial extent less than the radial extent of the component. In other arrangements in which there is a pylon, the pylon may not provide any structural supporting function and instead may provide a location to house cabling or power transmissions, for example. In the region of the merged portion the outlet guide vane and the structural support may have matching profiles so as to form a continuous aerodynamic profile.

The merged portion may have a radial extent less than the radial extent of the component. The outlet guide vane and the structural support may be axially spaced apart over a portion of their radial extent so as to form a gap between the outlet guide vane and the structural support. The gap may be provided at a radially inner region of the component.

The outlet guide vane may comprise a guide vane root portion and the structural support may comprise a structural support root portion. The guide vane root portion and the structural support root portion may be axially spaced apart so as to form the gap. The axial spacing between the guide vane root portion and the structural support root portion may be less than 0.5 times the radial extent of the component.

The outlet guide vane may be arranged to be upstream of the structural support. The leading edge of the structural support may be concave. The leading edge of the outlet guide vane may be inclined rearwards.

The structural support (or pylon) may comprise at least one structural support member (e.g. one pylon member) and a structural support (e.g. a pylon) fairing which defines at least a part of the outer surface of the structural support (or pylon).

The disclosure also relates to a gas turbine engine comprising a bypass duct, wherein a component in accordance with any statement herein extends across the bypass duct with the structural support structurally supporting a radially inner component of the gas turbine engine.

The skilled person will appreciate that except where mutually exclusive, a feature described in relation to any one of the above aspects may be applied mutatis mutandis to any other aspect. Furthermore except where mutually exclusive any feature described herein may be applied to any aspect and/or combined with any other feature described herein.

### DESCRIPTION OF THE DRAWINGS

Embodiments will now be described by way of example only, with reference to the Figures, in which:

FIG. 1 schematically shows a cross section through a gas turbine engine; and

FIG. 2 schematically shows a cross section through a bypass duct in which a component comprising an outlet guide vane and a structural support is located.

### DETAILED DESCRIPTION

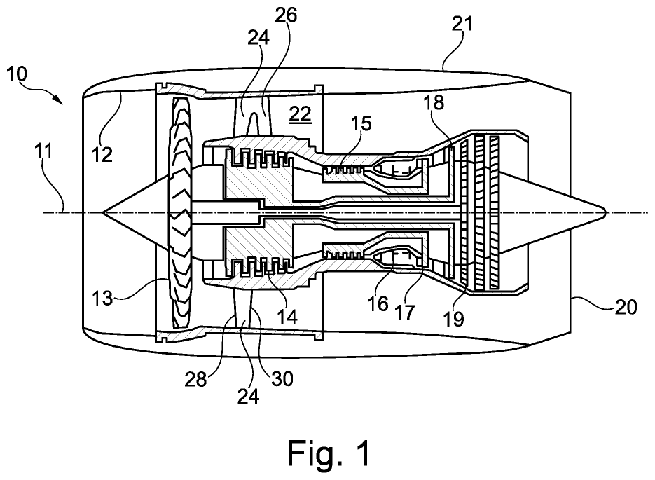

With reference to FIG. 1, a gas turbine engine is generally indicated at 10, having a principal and rotational axis 11. The engine 10 comprises, in axial flow series, an air intake 12, a propulsive fan 13, an intermediate pressure compressor 14, a high pressure compressor 15, combustion equipment 16, a high-pressure turbine 17, and intermediate pressure turbine 18, a low-pressure turbine 19 and an exhaust nozzle 20. A nacelle 21 generally surrounds the engine 10 and defines both the intake 12 and the exhaust nozzle 20.

The gas turbine engine 10 works in the conventional manner so that air entering the intake 12 is accelerated by the fan 13 to produce two air flows: a first air flow into the intermediate pressure compressor 14 and a second air flow which passes through a bypass duct 22 to provide propulsive thrust. The intermediate pressure compressor 14 compresses the air flow directed into it before delivering that air to the high pressure compressor 15 where further compression takes place. The compressed air exhausted from the high-pressure compressor 15 is directed into the combustion equipment 16 where it is mixed with fuel and the mixture combusted. The resultant hot combustion products then expand through, and thereby drive the high, intermediate and low-pressure turbines 17, 18, 19 before being exhausted through the nozzle 20 to provide additional propulsive thrust. The high 17, intermediate 18 and low 19 pressure turbines drive respectively the high pressure compressor 15, intermediate pressure compressor 14 and fan 13, each by suitable interconnecting shafts.

A plurality of circumferentially arranged outlet guide vanes 24 are located within and extend across the bypass duct 22 downstream of the fan 13. Each OGV 24 includes an aerofoil portion and has a leading edge 28 and a trailing edge 30. A pressure surface and a suction surface extend between the leading edge and the trailing edge. Each of the OGVs 24 may be twisted and leant so as to alter the axial and tangential position of the OGVs.

In the present arrangement a structural support in the form of a pylon 26 (or bifurcation) is provided downstream of the OGVs 24. In this arrangement there is a single pylon 26, but it should be appreciated that there may be two diametrically opposed pylons 26, or more than two pylons 26. Although not shown, the pylon 26 comprises one or more structural support rods (or members) provided with an outer in the form of aerodynamically shaped fairings. The pylon 26 both supports the engine core within the nacelle, and provides a housing for encasing and directing electrical connections. The pylon 26 may encase a radial drive shaft linking a case mounted accessory gearbox and the intermediate pressure compressor 14.

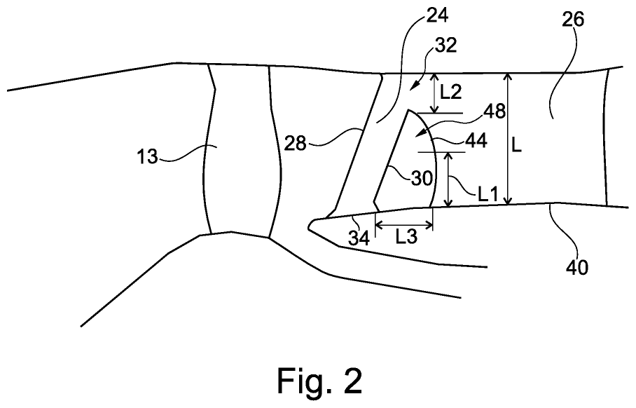

Referring now to FIG. 2, in the present arrangement the pylon 26, which is downstream of the OGVs, is contiguous with an outlet guide vane 24. The outlet guide vane 24 and the leading and trailing edges 28, 30 are inclined rearwards (from root to tip). The outlet guide vane 24 and the pylon 26 are contiguous at a merged portion 32 which is at a radially outer position. This is achieved by designing the pylon fairings 26 such that they match the profile of the outlet guide vane 24. This means that there is a smooth continuous aerodynamic surface between the outlet guide vane 24 and the pylon 26 in the region of merged portion. In this arrangement the outlet guide vane 24 and the pylon 26 are contiguous only along a portion of their radial extent L2. In particular, the radially inner root 34 of the outlet guide vane 24 is axially spaced from the radially inner root 40 of the pylon 26 by a distance L3. This forms a gap 48 between the trailing edge 30 of the outlet guide vane 24 and the leading edge 44 of the pylon 26.

The radially inner portion of the pylon 26 that is axially set-back from the trailing edge 30 of the outlet guide vane 24 has a radial extent L1. The leading edge 44 of the pylon 26 between the set-back portion and the merged portion 32 is in the form of a smooth curve. This results in the leading edge 44 of the pylon 26 having a concave shape. It should be appreciated that other geometries could be chosen depending on the desired operating conditions.

In this arrangement the merged portion 32 has a radial length L2 which is less than the radial length L of the pylon 26. The radial length L2 may be chosen such that that L2/L is no greater than 0.8, for example no greater than 0.5, for example no greater than 0.4, for example no greater than 0.3, for example no greater than 0.2, for example no greater than 0.1. The radial extent L1 of the set-back portion of the pylon may be chosen such that L1/L is between 0.2 and 0.8 and/or may be no greater than 0.5. The axial spacing L3 may be chosen such that L3/L is less than 0.7, for example less than 0.5, for example less than 0.3.

The merging of the outlet guide vane 24 and the pylon 26 results in improved flow guiding around the pylon 29. This may result in a more uniform flow field which may improve the fan operating range and may reduce the loading/forcing on the fan blades. Further, providing a gap 48 between the outlet guide vane 24 and the pylon 29 minimises the aerodynamic interaction between the outlet guide vane 24 and the pylon 26, resulting in improved aerodynamic performance.

It will be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

We claim:

1. A component arranged to extend across a bypass duct of a gas turbine engine, comprising:
an outlet guide vane; and
a structural support arranged to structurally support a radially inner component of the gas turbine engine;
wherein the outlet guide vane and the structural support are contiguous at a merged portion which is at a radially outer region of the component, and the merged portion has a radial extent (L2) less than the radial extent (L) of the component.

2. A component according to claim 1, wherein the outlet guide vane and the structural support are axially spaced apart over a portion of their radial extent so as to form a gap between the outlet guide vane and the structural support.

3. A component according to claim 2, wherein the gap is provided at a radially inner region of the component.

4. A component according to claim 2, wherein the outlet guide vane comprises a guide vane root portion and wherein the structural support comprises a structural support root portion, and wherein the guide vane root portion and the structural support root portion are axially spaced apart so as to form the gap.

5. A component according to any claim 4, wherein the axial spacing (L3) between the guide vane root portion and the structural support root portion is less than 0.5 times the radial extent (L) of the component.

6. A component according to claim 1, wherein the outlet guide vane is arranged to be upstream of the structural support.

7. A component according to claim 1, wherein the leading edge of the structural support is concave.

8. A component according to claim 1, wherein the leading edge of the outlet guide vane is inclined rearwards.

9. A component according to claim 1, wherein the structural support comprises at least one structural support member and a structural support fairing which defines at least a part of the outer surface of the structural support.

10. A gas turbine engine comprising a bypass duct, wherein a component in accordance with claim 1 extends across the bypass duct with the structural support structurally supporting a radially inner component of the gas turbine engine.
